(19) United States
(12) Patent Application Publication
(10) Pub. No.: US 2021/0246054 A1
(43) Pub. Date: Aug. 12, 2021

(54) METHOD OF REVITALIZING REVERSE OSMOSIS WATER

(71) Applicant: KEVIN E. FLAMMANG, Granville, IA (US)

(72) Inventor: KEVIN E. FLAMMANG, Granville, IA (US)

(21) Appl. No.: 16/783,349

(22) Filed: Feb. 6, 2020

(51) Int. Cl. C02F 1/68; C02F 1/34

(52) U.S. Cl. CPC C02F 1/68; C02F 1/441; C02F 1/34

(57) ABSTRACT

A process for revitalizing mineral deficient water, such as reverse osmosis water, includes the steps of passing the water through a conduit having internal deflectors which cause cavitation to increase negative hydrogen ions in the water and the step of flowing the water through a mineral sleeve so as to impart the mineral frequencies to the water for subsequent absorption by a body consuming the water, including people, animals, and plants.

### FIELD OF THE INVENTION

The invention is directed towards a method of treating reverse osmosis water so as to revitalize the water with increased negative hydrogen ions and enhanced mineral frequencies.

### BACKGROUND OF THE INVENTION

Reverse osmosis is a commonly used process for treating water to remove impurities, particularly minerals. This process passes the water through a membrane to filter out minerals, such as calcium and magnesium which are major contributors to water hardness.

Reverse osmosis is used for both residential and commercial applications, but creates concerns and risks with respect to drinking water.

Demineralized water is substantially free of dissolved minerals as a result of membrane filtration (reverse osmosis or nanofiltration), deciliation, deisolation, electroanalysis, or other technologies. The total dissolved solids (TDS) in such water maybe as low as 1 mg/L, and the electrical conductivity is generally less than 2 mS/m. However, minerals in water are important to the health of any body, including humans, animals and plants. Also, demineralized water is corrosive to metal pipes and storage tanks, because the water leaches metals and other materials from metal pipes and containers. Similarly, when consumed, demineralized water leaches minerals from the body of people, animals and plants. In a 1980 report, the World Health Organization concluded that demineralized water has a definite adverse influence on animals and humans, and recommended minimum and maximum levels of certain minerals. Demineralized and low-mineral (soft) water contribute to health issues, including mineral homeostasis, metabolism, mucus membrane, and other bodily functions.

Calcium and magnesium are both essential elements. Calcium is a substantial component of bones and teeth, and plays a role in neuromuscular excitability, proper functioning of the myocardial system, heart and muscle contractility, intracellular information transmission, and coagulability of blood. Magnesium plays an important role in more than 300 enzymatic reactions including glycolysis, ATP metabolism, transport of elements such as sodium, potassium, and calcium through membranes, synthesis of proteins and nucleic acids, neuromuscular excitability, and muscle contraction.

Decades of epidemiological studies from around the world have reported that soft water (i.e., water low in calcium and magnesium) is associated with increased mortality from cardiovascular disease, as compared to hard water. More recent studies also suggest that soft water consumption may be associated with a higher risk factor in children, certain neurodegenerative diseases, preterm birth and low weight birth, as well as some types of cancer.

Although drinking water normally is not a major source of essential elements for humans, the modern diet of many people does not provide an adequate source of minerals and microelements, such that even low intake of these elements in drinking water may have a protective role, since the elements in water are usually present as free ions so as to be more readily absorbed from the water, as compared to food wherein the elements are usually bound to other substances. Similarly, in animals, the presence or absence of microquantities of minerals and elements in water may have an effect on muscular tissue.

Also, cooking with demineralized water removes calcium, magnesium, and other essential elements from prepared food, which normally are absorbed by the body. When used for cooking, soft water causes substantial loss of all the essential elements from vegetables, meats and cereals, including calcium and magnesium. Cooking with hard water has substantially less loss of these minerals. In humans, most nutrients are ingested with food. Therefore, the use of low mineral water for cooking and processing food creates a deficiency in total intake of essential elements.

Also, since low-mineralized water is unstable and highly aggressive to metals, there is an increased risk of the presence of toxic metals in such water, which may then be consumed. Calcium and magnesium in water and food are known to have an antitoxic activity that can help and prevent the absorption of toxic elements, such as lead and cadmium.

Thus, demineralized or low-mineral water is not considered ideal drinking water such that its regular consumption maybe not be providing adequate levels of some beneficial nutrients. The adverse health consequences from drinking water deficient in calcium meant in magnesium is evidence from numerous studies of both humans and animals.

Therefore, a primary objective of the present invention is the provision of a method for revitalizing reverse osmosis water to provide health benefits in humans, animals and plants.

Another objective of the present invention is the provision of a method for improving the quality of soft water.

A further objective of the present invention is the provision of a method for increasing the hydrogen ions and mineral frequencies in low mineral water.

Still another objective of the present invention is the provision of a method for improving the health benefits of water treated by reverse osmosis and other processes for removing minerals.

Still another objective of the present invention is a provision of a water treatment method which overcomes the adverse effects of demineralization.

Yet another objective of the present invention is a provision of a treatment process for reverse osmosis water which is economical and effective.

These and other objectives will become apparent from the following description of the invention.

### SUMMARY OF THE INVENTION

A method is provided for revitalizing reverse osmosis water, which has had most, if not all, of its minerals removed therefrom. The method involves two steps which may be performed simultaneously or sequentially in either order: (1) flowing the reverse osmosis water through a conduit having demagnetized stainless steel balls or deflectors, which will create more negative hydrogen ions in the water; (2) exposing the reverse osmosis water to a mineral supply, preferably in a sleeve through which the water flows, such that the water acquires the mineral frequencies.

### BRIEF DESCRIPTION OF THE DRAWINGS

FIG. 1 is a schematic flow diagram showing one method of the present invention for revitalizing low mineral water, such as reverse osmosis water.

FIG. 2 is a schematic flow diagram showing an alternative method of the present invention for revitalizing mineral-deficient water.

FIG. 3 is a schematic flow diagram showing a further embodiment of the present invention for revitalizing low-mineral water.

FIG. 4 is a longitudinal cross-sectional view of a conduit or pipe according to the present invention for revitalizing the mineralized water.

FIG. 5 is a lateral cross-sectional view of the conduit shown in FIG. 4.

### DETAILED DESCRIPTION OF THE PREFERRED EMBODIMENTS

Minerals carry energy in the form of a band of frequencies within the full electromagnetic spectrum. Each mineral has a different frequency band, which may be narrow or broad. These mineral frequencies can be transmitted to other bodies, including water, to revitalize low mineral water, such as water treated by reverse osmosis. This energized water similarly transmits its mineral frequencies when consumed by a person, an animal, or a plant, which then receives the energy frequency signature of the minerals, thus restoring or increasing mineral deficiencies in the body. Thus, water, which has memory, picks up the energy frequencies of objects that it comes into contact with.

Low mineral or mineral deficient water, such as water treated by reverse osmosis, can be revitalized with the methods of the present invention. This revitalization changes the non-structured reverse osmosis water, sometimes known as “dead” water, into structured water having enhanced or revived properties. The process of the present invention involves flowing the reverse osmosis (RO) water through a conduit downstream from the reverse osmosis filter membrane. The RO water in the conduit is subjected to cavitation and to mineral frequencies, either simultaneously or sequentially.

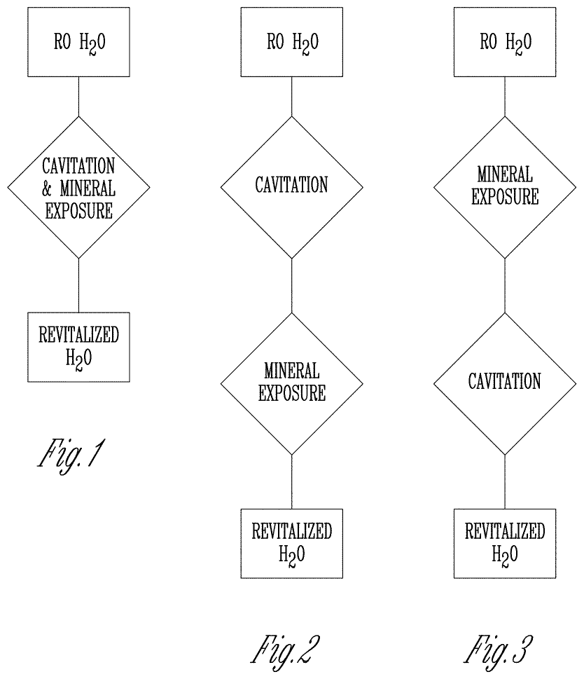

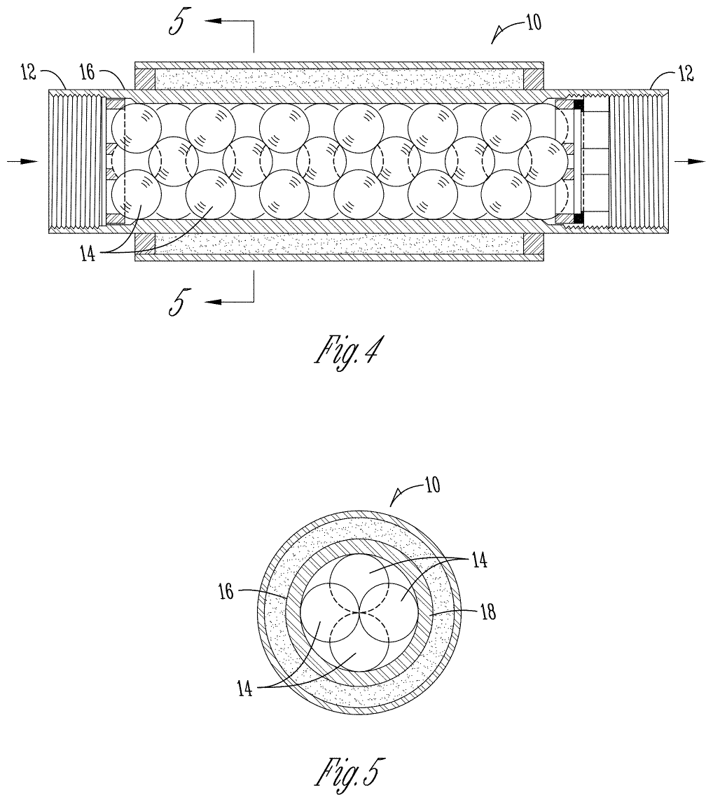

For example, in FIG. 1, the RO water, or other low mineral water, is cavitated and exposed to minerals at the same time. In an alternative embodiment, shown in FIG. 2, the cavitation step precedes the mineral exposure step. In a further alternative embodiment, the water is exposed to the mineral frequencies first, and then cavitated, as shown in FIG. 3.

In the preferred embodiment, the RO water passes through a conduit, pipe or tube 10, which transforms the water quality to an improved or enhanced condition by imparting mineral frequencies to the water and increasing negative hydrogen ions in the water. The conduit 10 has opposite threaded ends 12 for installation in a water supply line, in a location downstream from the reverse osmosis filter. A plurality of deflectors 14 are located inside the conduit 10. Preferably, the deflectors 14 are demagnetized stainless steel balls, though other forms of deflectors may be utilized. Also, the balls 14 are preferably arranged in a predetermined array, such as layers or rows of offset balls, over which the water flows so as to create cavitation for the water, similar to that derived from a stream wherein the water flows over stones or rocks. This cavitation causes the hydrogen molecules of the water to transform to create increased negative ions, which decreases the surface tension of the water, which in turn allows the water to be more readily absorbed into the cells of the body of a human, animal, or plant which consumes the water. The cavitation may include tumbling, spinning, twirling, stirring, vortexing, or spiraling.

The conduit 10 also has an outer sleeve 16 which is filled with selected minerals, such as calcium and magnesium. The minerals may be in the form of dust, or larger sized particles or crystals. As the water cavitates to the interior of the conduit, the frequency of the minerals in the sleeve 16 resonate into the water. Such resonance absorption allows the water to carry the frequencies into the body upon consumption, for transfer into the cells of the body.

The dense steel balls 14 activate the oxygen molecules in the water, and in turn releases or creates negative hydrogen ions. The resulting lower surface tension of the water molecules decreases the dynes, which allows the water to be more readily absorbed into the cells of the body. The revitalized water preferably has a surface tension in the range of 37-42 dynes.

The revitalization treatment process modifies the normal, large clustered molecules of the water, which are too large to penetrate the cells of a body, to a reduced size or micro-cluster of molecules which passes into the cells for improved hydration of the body.

The revitalized water, with its enhanced negative hydrogen ions, also functions to neutralize toxins in the body, which are normally positively charged. When the body cells are hydrated with the revitalized water resulting from the process of the present invention, the free radicals in the cells are eliminated by the electron donors.

The reverse osmosis process strips electron activity from the water molecules, such that the water is electrically “dead.” Electron activity in water is responsible for neutralizing free radicals in the body when the water is consumed. Because the reverse osmosis process removes hydrogen ions from the water, then steals electrons from the body upon consumption of the RO water, thus dehydrating the body. The revitalized water resulting from the re-treatment of the RO water restores the hydrogen ions, eliminates dehydration, and approves hydration of the body.

The mineral wrap of the sleeve 16 creates an abundance of negatively charged hydrogen ions containing the electron activity the body relies upon. The negatively charged hydrogen ions carry the electrons. The revitalized water provides an improved electrical interface at the cellular level, which depends on electrical conductivity, to transfer energy in the body, while also preserving minerals in the body, without losing the minerals through body fluids, such as urine and sweat. Thus, the revitalized water increases hydration at the cellular level for healthier bodily function.

The revitalized water resulting from the method of the present invention has increased negative hydrogen ions, which are powerful natural antioxidants to counteract damaging free radicals, which are major contributors due to degenerative diseases. The negative hydrogen gives up its electron, without becoming an unstable harmful-free radical. The negative hydrogen establishes a biological terrain wherein harmful microbes (such as yeasts, bacteria, viruses, and other parasites) do not remain or survive. The negative hydrogen ions display natural alkalizers and antimicrobial agents to maintain cellular fluid balance. The revitalization process produces water having free electrons with a negative hydrogen complex, which is necessary as the raw material for the mitochondria, and the source within cells to produce energy. The hydrogen to which the free electrons are attached is utilized to combat available oxygen expressed as energy produced. The electrons are carried throughout the living body by attachment to the abundance of hydrogen ions in the rejuvenated water.

The conduit 10 may have shapes other than the circular shape shown in FIG. 5, such as oval, square, round, oblong, non-symmetrical, dimpled, or irregular, and the like. The conduit 10 can also be used with other liquids, such as wine, liquor, milk, syrups, oils, and other liquids which are consumed in one form or another.

The deflectors 14 can also have shapes other than the spherical balls shown in FIG. 5. For example, the deflectors may be cubes, squares, diamonds, triangular, oblong, or other irregular shapes. Also, the deflectors can be made out of non-metallic material, such as glass, plastic, ceramic, or acrylic. The mineral sleeve 16 may also be made of any material, such as plastic, PVC, CPVC, copper, stainless steel, iron, glass, carbon, carbon fiber, grafting, tungsten, aluminum, ceramic, cast, pot metal, clay tile, tin, acrylic, rubber, and other materials.

The water created by the revitalization process may be used in various applications, including livestock, poultry, fish, irrigation for agricultural and greenhouse plant production, carwashes, laundries, ponds, lakes, and aquariums and on the soil. The process can also be used to revitalize and restructure water treated by reverse osmosis, desalination, salt softeners, and other types of filtered water and liquids. Furthermore, the process can be used with biological liquids and oils to control and dissipate odor from dead and decaying plants, animals or other contaminants. The revitalized water can also be used on various water shed products, pits, lagoons, tanks, septic, sewer treatment, drainage systems, and oil spills.

Thus, the person, animal, or plant which utilizes the revitalized water resulting from the methods of the present invention has improved hydration, reduced disease risk, and approved overall health. This restructuring of the water increases crop production or yield when used in agricultural irrigation systems, increases growth in animals when used in livestock, poultry, and fish farms.

The present invention can also be used for hydrogen fuel production through the increased volume or quantity of negative hydrogen ions. The number of hydration layers of ions increases thermal conductivity or heat transfer, which increases caloric capacity due to the bonding angles created by the micro-cluster molecules. The revitalized water with improved hydrogen bonding allows the hydrogen layers to surround the usable ionic state of energy with higher specific heat. Thus, the revitalized water with increased hydrogen bonding and increased negative hydrogen ions with bio-photonic energy provides a positive or enhanced water for hydrogen fuel production.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A method of revitalizing reverse osmosis water, comprising:
passing the reverse osmosis water through a conduit having internal deflectors; and
running the reverse osmosis water in the conduit past a segregated mineral supply outside the conduit so that the mineral frequencies are absorbed by the water.

2. The method of claim 1 wherein the deflectors are round.

3. The method of claim 1 wherein the deflectors are metal.

4. The method of claim 1 wherein the deflectors are demagnetized.

5. The method of claim 1 wherein the deflectors are arranged in an array.

6. The method of claim 1 wherein the deflectors are balls arranged in offset rows.

7. The method of claim 1 wherein the mineral supply is in a sleeve surrounding the running water.

8. The method of claim 1 wherein the minerals are selected from a group consisting of calcium, magnesium potassium and sodium.

9. A method of treating demineralized water, comprising:
directing the demineralized water through a tube surrounded by minerals to add mineral frequencies to the water.

10. The method of claim 9 wherein the minerals include calcium and magnesium potassium.

11. The method of claim 9 wherein the minerals and the water are segregated.

12. The method of claim 9 wherein the water is isolated from the minerals.

13. The method of claim 9 further comprising flowing the water around deflectors in the tube to increase negative hydrogen.

14. The method of claim 13 wherein the deflectors are demagnetized steel balls.

15. A method of providing health benefits from consumption of water, comprising:
exposing reverse osmosis water to minerals without directly contacting the minerals to increase mineral frequencies in the water;
cavitating the reverse osmosis water to increase negative hydrogen ions in the water; and then consuming the water.

16. The method of claim 15 wherein the exposing and cavitating steps occur simultaneously.

17. The method of claim 15 wherein demagnetized stainless steel deflectors are used to create the cavitation.

18. The method of claim 15 wherein the minerals are isolated from the reverse osmosis water.

19. The method of claim 18 wherein the minerals are housed in a non-perforated shell, with the water contacting the shell.

20. The method of claim 15 wherein the minerals include calcium and magnesium.
